(19) United States
(12) Patent Application Publication
(10) Pub. No.: US 2026/0276598 A1
(43) Pub. Date: Sep. 17, 2026

(54) SYSTEMS AND METHODS FOR SYNCHRONIZING ROTATIONAL AND TRANSLATIONAL MOTION WITH ULTRASONIC MEASUREMENTS

(71) Applicant: HEXAGON TECHNOLOGY AS, Alesund (NO)

(72) Inventors: Brian Burks, Parker, CO (US); Gabriel Kalmar, Centennial, CO (US); William Charlesworth, Denver, CO (US); Troy Otto, Aurora, CO (US)

(21) Appl. No.: 19/669,828

(22) Filed: May 6, 2026

Related U.S. Application Data
(63) Continuation of application No. PCT/IB2024/061064, filed on Nov. 7, 2024.
(60) Provisional application No. 63/547,754, filed on Nov. 8, 2023.

(51) Int. Cl. G01N 29/22; G01N 29/04; G01N 29/275; G01N 29/34

(52) U.S. Cl. CPC G01N 29/223; G01N 29/04; G01N 29/275; G01N 29/343; G01N 2291/0234; G01N 2291/02854; G01N 2291/101; G01N 2291/2634

(57) ABSTRACT

A non-direct drive cylinder defect detection system is disclosed. A non-direct drivetrain system may include a plurality of rollers rotatably driven by a shaft. The plurality of rollers can receive and cause a cylinder to spin while rested thereon. An encoder system is disclosed and is configured to detect a rotary position of a portion of the cylinder.

### CROSS-REFERENCE TO RELATED APPLICATIONS

This application claims the benefit of U.S. Provisional Application No. 63/547,754, filed Nov. 8, 2023, the entire contents of which is incorporated herein by reference.

### FIELD

This disclosure relates to testing of cylinders for defects such as cracks, wall thinning, or other forms of defects.

### BACKGROUND

Having precise control over the synchronization of rotational and translational motion is critical to effectively employing automated ultrasound scanners that are often used in the periodic inspection of seamless metallic cylinders. For example, many national body and international standards require that a 10% overlap in the ultrasound measurements be kept so as to not avoid missing a rejectable defect.

A penalty in use of a direct drive drivetrain system is that cylinder handling and motion may become complicated due to a need to position the center line of cylinders (e.g., having variable diameter) at the centerline of the drivetrain when the ultrasound inspection is to be performed.

Previous automated ultrasound systems that employ non direct drive drivetrains rely on allowing the cylinder to lay on a bed of rollers which are attached to shafts which are rotated by a motor. In operation, the self weight of the cylinder and the frictional force between the cylinder and bed of rollers may result in rotational motion of the cylinder when the motor that is connected to the shafts operates. One drawback with such systems is mechanical slip between the cylinder and the bed of rollers. Current systems fail to reliably measure or account for mechanical slip.

### SUMMARY

Aspects of this disclosure include a system for synchronizing rotational and translational motion of an ultrasound probe or scanning head with ultrasound measurements of a cylinder when the cylinder is rotated by a system whose drivetrain is not direct drive. Aspects of the present disclosure address mechanical slip issues present in the prior art.

In some aspects, a non-direct drive cylinder defect detection system is disclosed. The non-direct drivetrain system may include a plurality of rollers rotatably driven by a shaft. The plurality of rollers can receive and cause a cylinder to spin while rested thereon. An encoder system may be configured to detect a rotary position of a portion of the cylinder. The encoder system may be positioned adjacent the plurality of rollers.

In some aspects, the encoder system includes a vacuum sealing cup configured to connect to an end of the cylinder during testing operations. A rotary encoder can be included with a rotating shaft connected to the vacuum sealing cup, the rotary encoder configured to detect the rotary position of the cylinder.

In some aspects, a vacuum rotary union housing is included, wherein the rotating shaft runs from the rotary encoder through the vacuum rotary union housing.

In some aspects, the vacuum sealing cup is configured to mechanically attach to the end of the cylinder by forming a vacuum seal coupling.

In some aspects, a vacuum force is formed between the vacuum sealing cup and the cylinder that is larger than a frictional drag developed in the rotary encoder by rotation caused by the rotating shaft during testing operations.

In some aspects, the cylinder is non-ferrous or ferrous.

In some aspects, the encoder system includes a connector plate driven by a rotating shaft and is configured to connect to an end of the cylinder, the connector plate being at least partially magnetic or comprising one or more magnetic connectors. The encoder system includes a rotary encoder coupled to the rotating shaft that runs from the rotary encoder through the connector plate, the rotary encoder configured to detect the rotary position of the cylinder.

In some aspects, a magnetic force is formed between the connector plate and the cylinder is larger than a frictional drag developed in the rotary encoder by rotation caused by the rotating shaft during testing operations.

In some aspects, the cylinder includes a ferrous connector positioned on the end of the cylinder to form the magnetic force between the cylinder and the connector plate.

In some aspects, the cylinder includes a base end with a first coupling pattern. The encoder system includes a mounting plate configured to connect to an end of the cylinder. The mounting plate includes a second coupling pattern shaped to connect with the first coupling pattern. A rotary encoder can be coupled to the mounting plate, the rotary encoder being configured to detect the rotary position of the end of the cylinder.

In some aspects, the first coupling pattern is formed in the base end by one or more notches selectively positioned to align with the mounting plate.

In some aspects, during testing operations, the second coupling pattern of the mounting plate is configured to mechanically lock and unlock with the first pattern of the base end of the cylinder.

In some aspects, the cylinder includes an encoder ring pattern positioned on a base end. The encoder system in this example includes an optical encoder configured to detect the rotary position of the end of the cylinder by tracking rotational motion of cylinder by reading position information of the encoder ring pattern during testing operations.

In some aspects, the encoder ring pattern is engraved or otherwise shaped with the base end of the cylinder.

In some aspects, the encoder ring pattern is scribed, laser etched, and/or otherwise mechanically formed with the base end of the cylinder.

In some aspects, the optical encoder includes a spectrophotometer or a color encoder. The encoder ring pattern can include a color gradient to measure the rotary position of the cylinder during testing operations. In some aspects, the color gradient of the encoder ring pattern is attached or otherwise adhered to the cylinder.

In some aspects, the portion of the cylinder detected by the encoder system is a base portion of the cylinder.

In some aspects, an adjustable receiving/transmitting transducer is positioned to mount proximal to the cylinder.

In some aspects, the non-direct drivetrain system includes a motor coupled to a gear box, wherein the gear box is coupled to an output shaft that passes through a bearing housing mounted in a wall of a fluid tank and into contact with the plurality of rollers.

In some aspects, the system can include a fluid tank for providing fluid for use in testing operations.

In some aspects, the cylinder has a cylinder valve.

In some aspects, the system is portable.

In some aspects, a method is disclosed for testing for the presence of a cylinder defect. The method includes arranging at least a portion of a cylinder in a measuring position relative to a plurality of rollers and an encoder system of a non-direct drive ultrasonic scanning system; spinning, by the plurality of rollers, the cylinder; moving an ultrasonic transducer into proximity with the cylinder; detecting, by the encoder system, a rotary position of a portion of the cylinder; synchronizing, based on the rotary position, rotational and translational motion of an ultrasonic transducer of the non-direct drive ultrasonic scanning system; and determining, using the rotary position and signals from the ultrasonic transducer of the non-direct drive ultrasonic scanning system, whether a defect of the cylinder is present.

In some aspects, the encoder system of the method is any encoder system of this disclosure.

In some aspects, the method includes detecting, by the ultrasonic transducer, a set of signals resulting from a set of ultrasonic pulses.

In some aspects, provided herein are examples of coupling an auxiliary rotational encoder to a cylinder under test being driven by a non direct drive drivetrain while using the feedback from the auxiliary rotational encoder to synchronize the rotational and translational motion of the scanning head and the ultrasound pulser receiver unit so that precise control of where measurements are made on the cylinders surface are divulged. The examples described herein overcome the issue of mechanical slippage possible in non direct drive systems ensuring that national body and international periodic inspections are performed properly.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a top view drawing of a direct-drive ultrasonic scanning system.

FIG. 2 is a front view drawing of a direct-drive ultrasonic scanning system.

FIG. 3 is a perspective view of an ultrasonic cylinder scanning system with one or more non-direct drivetrains.

FIG. 4 is a perspective view of an example rotary encoder system for use with the ultrasonic cylinder scanning system of FIGS. 3A to 3B.

FIG. 5 is a perspective view of an example rotary encoder system for use with the ultrasonic cylinder scanning system of FIGS. 3A to 3B.

FIG. 6A is a perspective view of an example cylinder for use with an example rotary encoder system of the ultrasonic cylinder scanning system of FIGS. 3A to 3B.

FIG. 6B is a close-up of section 6B-6B of FIG. 6A.

FIG. 7A is a perspective view of an example cylinder for use with an example rotary encoder system of the ultrasonic cylinder scanning system of FIGS. 3A to 3B.

FIG. 7B is a close-up of section 7B-7B of FIG. 7A.

FIG. 8A is a perspective view of an example cylinder for use with an example rotary encoder system of the ultrasonic cylinder scanning system of FIGS. 3A to 3B.

FIG. 8B is a close-up of section 8B-8B of FIG. 8A.

FIG. 9 is a flow chart of operating an example rotary encoder system, according to the present disclosure.

FIG. 10 is a computer architecture diagram showing a computing system for implementing aspects of the present disclosure in accordance with one or more examples described herein.

### DETAILED DESCRIPTION

Although examples of the disclosed technology are explained in detail herein, it is to be understood that other examples are contemplated. Accordingly, it is not intended that the disclosed technology be limited in its scope to the details of construction and arrangement of components set forth in the following description or illustrated in the drawings. The disclosed technology is capable of other examples and/or of being practiced or carried out in various ways.

It must also be noted that, as used in the specification and the appended claims, the singular forms “a,” “an” and “the” include plural referents unless the context clearly dictates otherwise. By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

Relative terms, such as “about,” “substantially,” or “approximately” are used to include small variations with specific numerical values (e.g., +/−x %,), as well as including the situation of no variation (+/−0%). In some examples, the numerical value x is less than or equal to 10—e.g., less than or equal to 5, to 2, to 1, or smaller.

The mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

A variety of ultrasonic testing methods and equipment for ultrasonic testing of cylinders are described U.S. Pat. No. 6,851,319 B2 issued Feb. 8, 2005, which is incorporated by reference in its entirety for all purposes as if set forth verbatim herein.

As discussed herein, “operator” may include, but is not limited to, a technician, an engineer, or other professional, or any other suitable individual associated with the ultrasonic testing of cylinders.

The terms “distal” or “proximal” are used in the following description with respect to a position or direction relative to a reference point. “Distal” or “distally” are a position distant from or in a direction away from the reference point. “Proximal” or “proximally” or “proximate” are a position near or in a direction toward the reference point.

In some aspects, the present disclosure provides a description of devices, systems, and methods to meet requirements under certain governing bodies (e.g., Department of Transportation (DOT)) for the ultrasonic testing or retesting of cylinders for certain defects and to measure cylinder wall thickness. For example, DOT requires that cylinders used for over-the-road transportation of pressurized gases and liquids be retested at periodic intervals to ensure that no defects of a critical size exist in the cylinders.

The term, “cylinder” and other types of containers of this disclosure are typically made of steel but can also be aluminum or some other metal (or even certain plastics or other polymers) or other materials depending on the application.

Although often discussed herein simply in terms of cylinders for convenience and illustration, it will be recognized that pipes, tanks, plates, spheres and other container structures can be tested using the methods and devices herein. That is, the methods herein are suitable to a variety of container configurations (pipes, spheres, plates, tanks, etc.) and are especially applicable to cylindrical objects like gas cylinders and pipes or other objects. The cylinders in implementations herein may include valves (cylinder valves) as desired.

Cracks in cylinder walls can be oriented axially or circumferentially. In either case, the crack surface can be tilted away from perpendicular to the cylinder surface, which may change the reflection intensity of a delivered ultrasonic beam, depending on the angle between the beam and the crack.

### Description of Direct Drive Systems

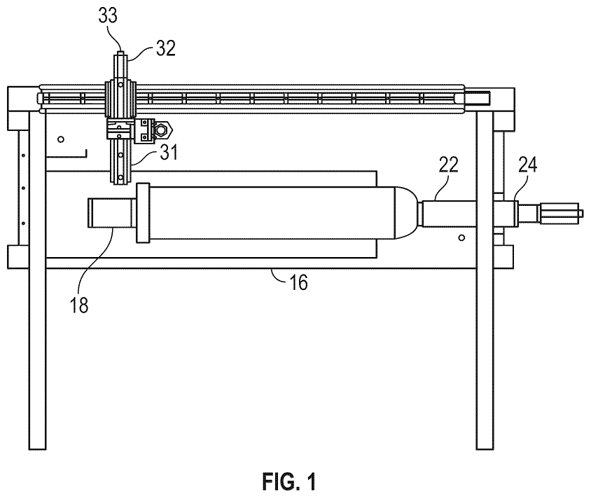

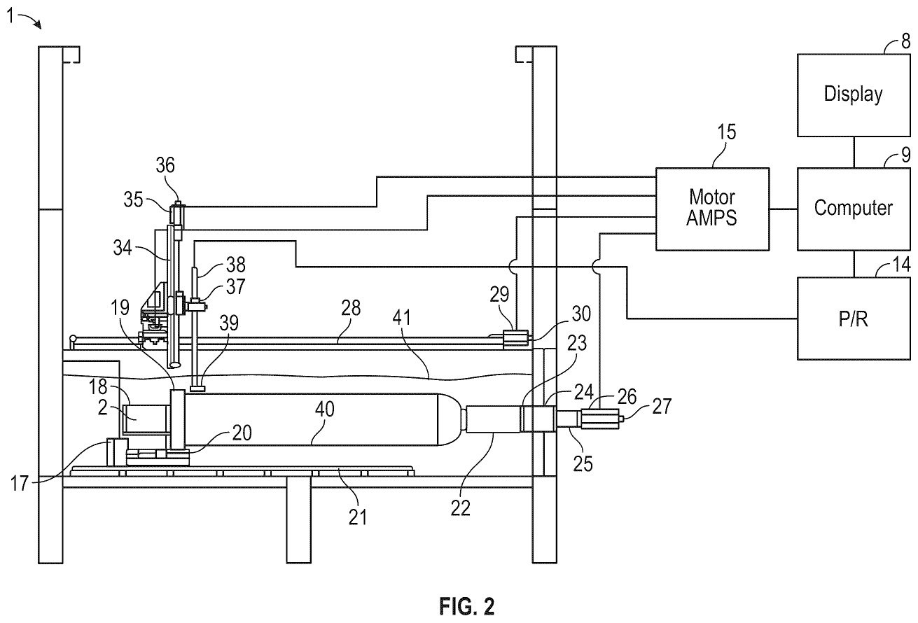

FIGS. 1-2 depict an ultrasonic scanning system 1 of previous disclosure, U.S. Pat. No. 6,851,319, issued Feb. 8, 2005, which is a direct-drive system and which is incorporated by reference in its entirety for all purposes. As shown, system 1 can include display 8, computer 9, a pulser/receiver module 14, motor amplifiers 15, tank 16, pneumatic cylinder 17, tailstock assembly 2 (which includes, e.g., bearing housing 18, cup 19, linear slide 20, and tailstock linear slide 21), self-centering cap 22, output shaft 23, bearing housing 24, gear box 25, rotary motor 26, rotary motor encoder 27, x-axis linear table 28, x-axis motor 29, x-axis encoder 30, y-axis linear table 31, y-axis motor 32, y-axis encoder 33, z-axis linear table 34, z-axis motor 35, z-axis encoder 36, rotatable search tube holder 37, search tube 38, ultrasonic sensor 39, cylinder 40, and coupling fluid 41.

When in use, the tank 16 of system 1 is filled with coupling fluid 41 (e.g., water). Cylinder 40 is placed in the tank between cup 19 and self-centering cap 22. Pneumatic cylinder 17 is then activated, moving the tailstock assembly along linear slide 20. This forces the cylinder into intimate contact with cup 19 and self-centering cap 22. Various lengths of cylinders are accommodated by adjusting the tailstock location along tailstock linear slide 21 and locking the tailstock assembly into place. Bearing housing 18 allows cup 19 to spin. In system 1, cylinder 40 is spun by activating rotary motor 26. Rotary motor 26 is attached to gear box 25. Gear box 25 is attached to output shaft 23 through bearing housing 24, and self-centering cap 22 is attached to output shaft 23.

In system 1, ultrasonic sensor 39 is held in position by being attached to rigid search tube 38. Search tube 38 is mounted in rotatable search tube holder 37, which is then attached to z-axis linear table 34. Ultrasonic sensor 39 is positioned relative to cylinder 40 by activating x-axis motor 29, y-axis motor 32, and z-axis motor 35. The motion is constrained by x-axis linear table 28, y-axis linear table 31 and z-axis linear table 34. An x-y-z position of the sensor is determined by encoder outputs of x-axis encoder 30, y-axis encoder 33, and z-axis encoder 36. Sensor position is read by computer 9 using motion control hardware. Motor amplifiers 15 provide power to the motors.

In system 1, as cylinder 40 is spun, ultrasonic sensor 39 is translated the length of cylinder 40 by x-axis linear table 28. The spinning and linear translation create a helix down the length of the cylinder. The rotary position of the cylinder is determined by the output of the rotary motor encoder 27. Output of rotary motor encoder 27 is read by a counter on trigger board and used to trigger pulser/receiver module 14. At specific intervals determined by the user, a high voltage electrical pulse from pulser/receiver module 14 is sent to ultrasonic sensor 39. This creates an ultrasonic pulse that propagates through coupling fluid 41 and into a wall of cylinder 40. The pulse echoes back from the wall of cylinder 40, and is detected by ultrasonic sensor 39. Ultrasonic sensor 39 sends a signal to pulser/receiver module 14, which amplifies and filters the received signal and sends a trigger pulse to an A/D converter. The signal is then digitized by the A/D converter, and then stored in an electronic format for analysis by software.

### Description of Example Non-Direct Drives

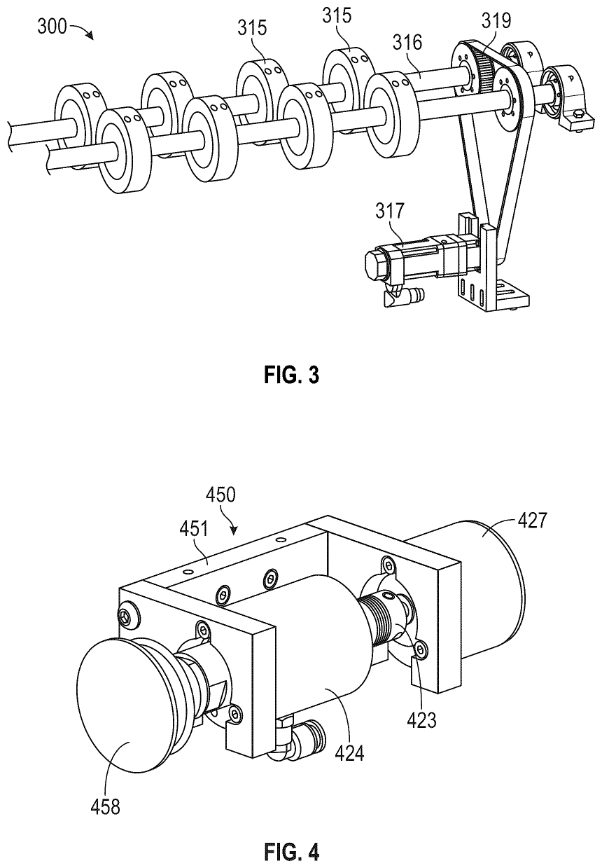

Turning to FIG. 3, a perspective view is provided of an ultrasonic cylinder scanning system 300 with one or more non-direct drivetrains. As shown, system 300 can include one or more rollers 315 in a tank 16 to cause the previously described cylinder 40 to rotate while rested thereon (e.g., positioned on top of the rollers 315). The rollers 315 are driven by a shaft 316. The system that causes the rollers 315 to rotate may include mechanical features as disclosed in regard to the system 1, for example, the cylinder 40 is spun by activating a rotary motor 317, which may be attached to a gear box, which may couple to a gear pulley 319. The gear box is accordingly attached to the shaft 316, which may pass through a bearing housing mounted in a wall of a fluid tank and into contact with the rollers 315. The testing may occur within a fluid tank. The rollers 315 receive and cause the cylinder 40 to spin while rested thereon. The rollers 315 rotate the cylinder 40 with friction. Any mechanical feature as disclosed in regard to the system 1 may be utilized. Further, the ultrasonic sensor 39 may be utilized in a manner disclosed in regard to the system 1. Testing utilizing the ultrasonic sensor 39 may be utilized in a manner disclosed in regard to the system 1. As previously noted, there can be slippage between the one or more rollers 315 and cylinder 40 during testing operations when cylinder 40 is being spun. The following examples address this slippage by synchronizing the rotational, translational, and ultrasound measurements, which ensures the integrity of any tests conducted using system 300.

By synchronizing the rotational, translational, and ultrasound measurements, the most accurate ultrasonic C-scan is obtained. Historically, this has been accomplished with a direct drivetrain. However, with the systems and methods disclosed herein, the auxiliary encoder, coupled directly to the rotating cylinder under test in a non-slip fashion, may provide the same level of information that the encoder of the rotational motor did in the direct drivetrain configuration. With the most accurate possible C-scan (i.e., defects not being skewed due to slip of the cylinder under test), defects from gas pressure cylinders (with principal stress axes in the axial and circumferential direction) will be perfectly aligned with the principal stress directions which aids automated flaw detection algorithms in properly identifying rejectable defects.

The examples of any of FIGS. 4-10 may be utilized with the ultrasonic cylinder scanning system 300 of FIG. 3. Turning to FIG. 4, an example rotary encoder system 450 is illustrated. The encoder system 450 is configured to detect a rotary position of a portion of the cylinder 40. The portion may comprise a base portion of the cylinder 40 in aspects herein. System 450 can include one or more rotary encoders 427 with a rotating shaft 423 that runs from encoder 427 through a vacuum rotary union housing 424. Housing 424 can be positioned within a mount 451 that can attach directly to aspects of prior described system 300 (e.g., housing mounted in a wall of a fluid tank). One or more vacuum sealing cups 458 can be positioned on a distal end of shaft 423 and distal of mount 451. In some aspects, the one or more cups 458 can be configured to connect to a distal end of a cylinder 40 during testing operations (e.g., mechanically attach to by forming a vacuum seal coupling with a corresponding end of cylinder 40). The rotary encoder 427 has a rotating shaft 423 that is connected to the vacuum sealing cup 458. The rotary encoder 427 is configured to detect the rotary position of the end of the cylinder 40. In some aspects, the one or more cups can utilize one more vacuum forces to adhere to cylinder 40. In some aspects, the example vacuum force between the one or more cups 458 and cylinder 40 can be sufficiently larger than any frictional drag capable of being developed in the rotary encoder 427 during testing operations (e.g., frictional drag developed in the rotary encoder 427 by rotation caused by the rotating shaft 423 during testing operations). System 450 is particularly advantageous since it can be used with any non-direct drive system, such as system 300, and with ferrous or non-ferrous cylinders 40.

During operations, after cylinder 40 and the one or more cups 458 have connected, then cylinder 40 is spun. The rotary position of cylinder 40 is determined by the output of encoder 427. Output of rotary encoder 427 is read (e.g., by a counter on a trigger board and used to trigger the ultrasound pulser/receiver module 14). Based on the detected rotary position, the system can synchronize any detected slippage based on the rotary position with rotational and translational motion of its ultrasonic transducer. The ultrasonic transducer may comprise an adjustable receiving/transmitting transducer positioned to mount proximal to the cylinder 40. In some aspects, at specific intervals measured by the rotary encoder, a high voltage electrical pulse from a pulser/receiver module can be sent to an ultrasonic sensor of the system. This creates an ultrasonic pulse that propagates and into a wall of cylinder 40. The pulse echoes back from the wall of cylinder 40 and is detected by the ultrasonic sensor. In some aspects, the ultrasonic sensor can send a signal to pulser/receiver module, which amplifies and filters the received signal and sends a trigger pulse to an A/D converter. The signal is then digitized by the A/D converter, and then stored in an electronic format for analysis by aspects of a connected computer system. All of these operations can take place in the non-direct drive system 300 while also accounting for slippage.

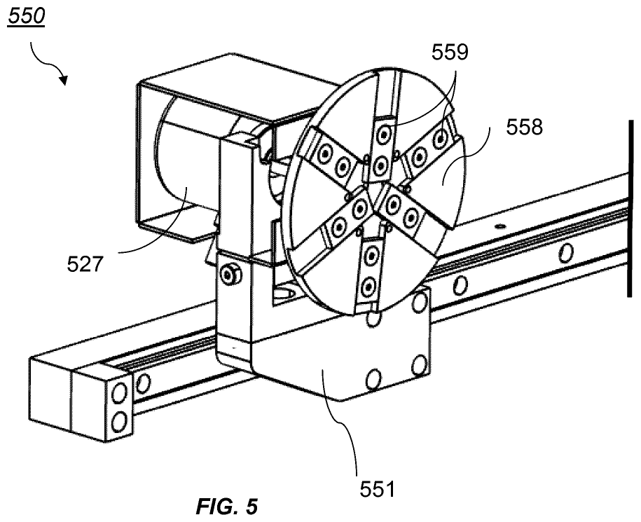

Turning to FIG. 5, another example rotary encoder system 550 is illustrated. System 550 can include one or more rotary encoders 527 with a rotating shaft that runs from encoder 527 through a mount 551 that can attach directly to aspects of prior described system 300, such as the illustrated linear table of FIG. 5. One or more connector plates 558 can be positioned on a distal end of the rotating shaft and distal of mount 551. In aspects, the rotary encoder 527 is coupled to a rotating shaft that runs from the rotary encoder 527 through the connector plate 558, the rotary encoder 527 configured to detect the rotary position of the end of the cylinder 40. In some aspects, the one or more plates 558 can be rotatable (e.g., with one or more rotational bearings) and be magnetic. In some aspects, the one or more plates 558 can be rotatable and include one or more embedded magnetic connectors 559. The connector plate 558 is driven by a rotating shaft and is configured to connect to an end of the cylinder 40, the connector plate 558 being at least partially magnetic or comprising one or more magnetic connectors 559.

Similar to system 450, system 550 can be configured to connect to a distal end of cylinder 40 during testing operations (e.g., mechanically attach to by forming a magnetic coupling with a corresponding end of cylinder 40 or the flange of a tube or any other cylinder being tested). In aspects, the cylinder 40 comprises a ferrous connector positioned on the end of the cylinder 40 to form the magnetic force between the cylinder 40 and the connector plate 558. In some aspects, the magnetic force formed by attaching one or more plates 558 to cylinder 40 under test is sufficiently large to overcome any mechanical drag force or other slippage which can be developed in the rotary encoder 527 (e.g., frictional drag developed in the rotary encoder 527 by rotation caused by the rotating shaft during testing operations). System 550 is particularly advantageous since it can be used with any non-direct drive system, such as system 300, and with ferrous cylinders 40.

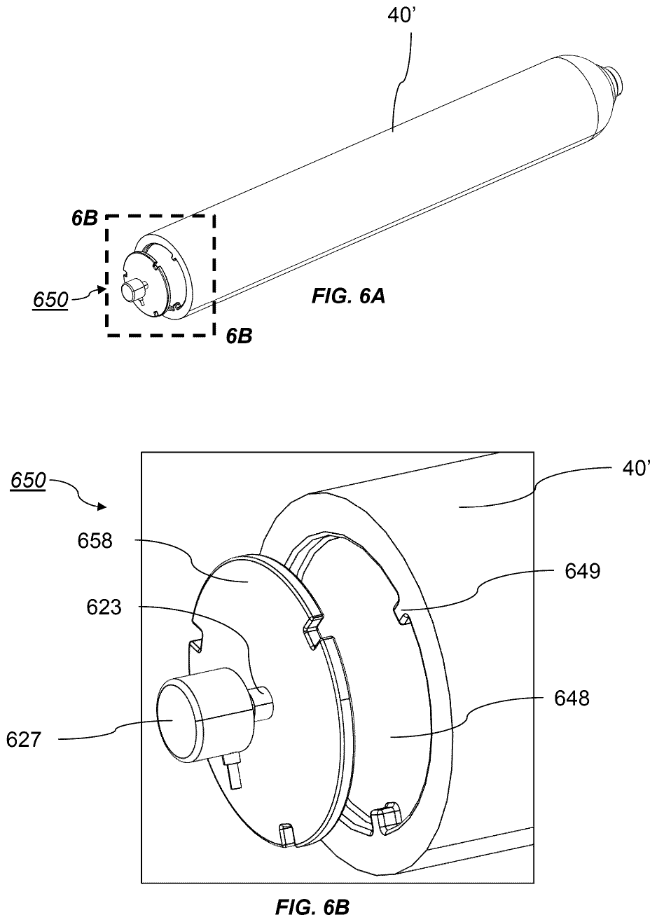

Turning to FIG. 6A, another example rotary encoder system 650 is illustrated in an exploded state with an example cylinder 40′, which is modified at its mounting end with respect to prior cylinders 40 of this disclosure. As further illustrated in FIG. 6B, which shows a close-up of section 6B-6B of FIG. 6A, modified cylinder 40′ here can include a coupling pattern or locating pattern at its base end or shaped in its base surface 648. Base surface 648 can include one or more notches 649 or other registration features that are selectively positioned to align with mounting plate 658 of system 650. The one or more notches 649 are formed in the base end and are selectively positioned to align with the mounting plate 658. Similar to prior examples, plate 658 can include a rotational bearing feature that is connected to the input shaft 623 of rotary encoder 627. During operations, plate 658 can mechanically lock and unlock to cylinder 40′ during testing operations. The mounting plate 658 is configured to connect to an end of the cylinder 40′, the mounting plate 658 including a coupling pattern or locating pattern shaped to connect with the coupling pattern or locating pattern of the cylinder 40′. In some aspects, as the cylinder 40′ is rotated the rotary encoder 627 can precisely track the circumferential position of cylinder 40′, similar to testing operations of previous rotational encoders of this disclosure. The rotary encoder 627 is configured to detect the rotary position of the end of the cylinder 40′. In some embodiments, cylinder 40′ is removably coupled to a base that has the locating pattern or coupling pattern shaped in its base surface. In this way, the base can be temporarily attached to a cylinder for testing, regardless of whether the cylinder has the locating pattern or coupling pattern shaped in its base surface. The removable base may be temporarily coupled to the cylinder using any method, such as interference fit or a temporary adhesive.

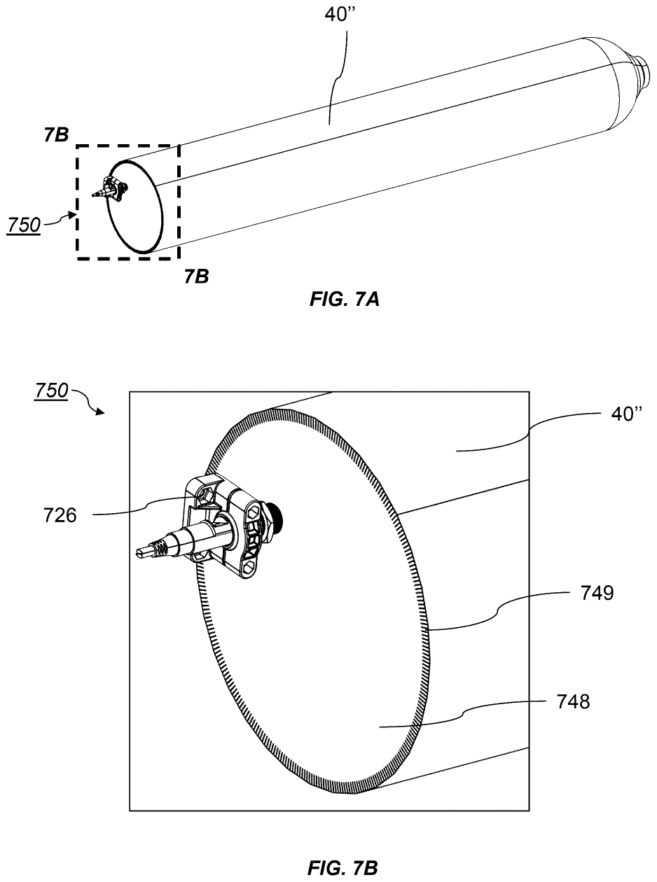

Turning to FIG. 7A, another example rotary encoder system 750 is illustrated in an exploded state with another example cylinder 40″, which is modified at its mounting end with respect to prior cylinders 40 of this disclosure. As further illustrated in FIG. 7B, which shows a close-up of section 7B-7B of FIG. 7A, modified cylinder 40″ here can include a locating encoder ring pattern 749 engraved or otherwise shaped in its base surface 748 at the base end of the cylinder 40″. In some aspects, pattern 749 can be scribed, laser etched, or otherwise mechanically formed (e.g. printed or adhered, among other methods) on the base surface 748 at the base end of the cylinder 40″. System 750 can include an optical encoder 726 configured to track the rotational motion of cylinder 40″ by reading position information of pattern 749. The optical encoder 726 is configured to detect the rotary position of the base end of the cylinder 40″ by tracking rotational motion of the cylinder 40″ by reading position information of the encoder ring pattern 749 during testing operations. In some aspects, encoder 726 is selectively positioned with previous system 300 in a position and orientation to measure the circumferential position of cylinder 40″ during testing. In some aspects, pattern 749 can be formed by being affixed to the cylinder (i.e. not engraved but adhered to base surface 748).

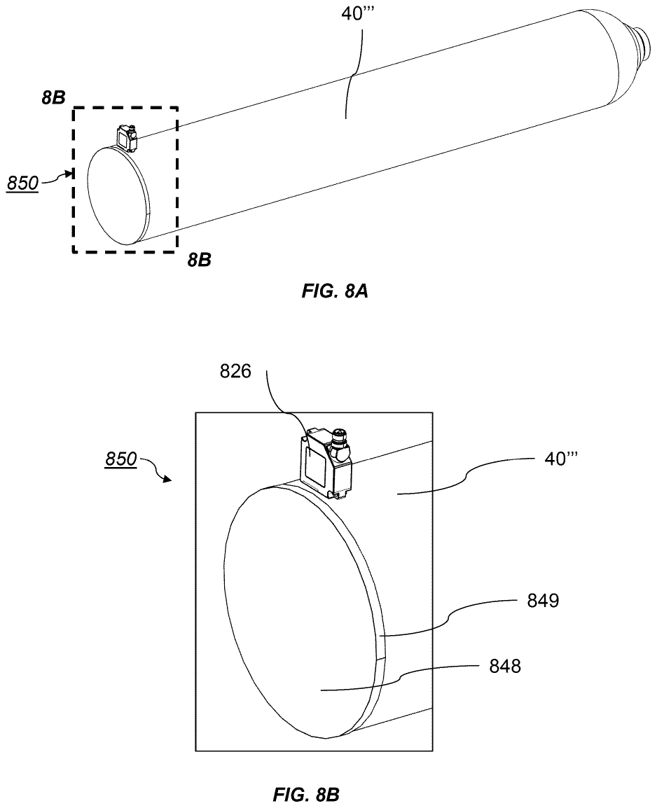

Turning to FIG. 8A, another example rotary encoder system 850 is illustrated in an exploded state with another example cylinder 40″′, which is modified at its mounting end with respect to prior cylinders 40 of this disclosure. As further illustrated in FIG. 8B, which shows a close-up of section 8B-8B of FIG. 8A, modified cylinder 40″′ here can include a locating encoder ring pattern 849 affixed or otherwise applied about its base surface 848. System 850 can include a spectrophotometer/color encoder 826 that is used to track the rotational position of the cylinder 40″′. In some aspects, pattern 849 can include a color gradient that is applied using a sticker of defined length, or otherwise mechanically introduced (e.g. printed, attached, or adhered, among other methods) on the base of cylinder 40″′. The color gradient may be used to measure the rotary position of the cylinder 40″′ during testing operations. In some aspects, the color sensing encoder 826 is positioned to measure the circumferential position of pattern 849 and therefore the circumferential position of cylinder 40″′ during testing.

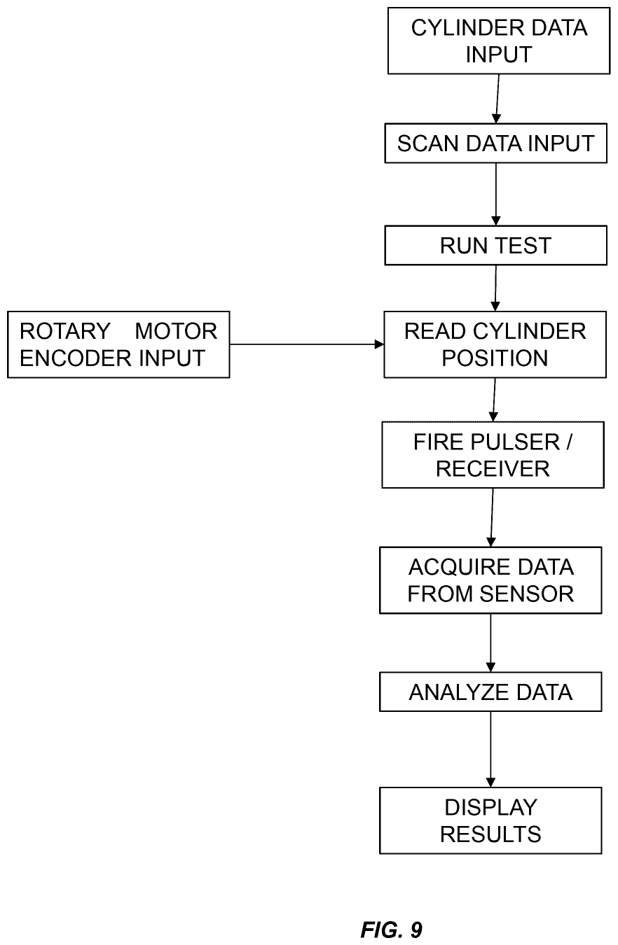

FIG. 9 shows the flow chart of operating an example rotary encoder system according to any example herein. During the depicted operations, one or more computer systems can be used to control motion of the system 300 with any herein disclosed encoder system (e.g., systems 450, 550, 650, 750, 850) for data acquisition, and data analysis. In some aspects, motion control is performed by data input by the operator. Cylinder length, diameter, minimum wall thickness and material properties can be input and rotation speed, scanning resolution, scan start and stop positions, A/D converter rate, data acquisition window length, signal delay, and sensor offset angle are also input. After the scanning data is input, the operator can scan a cylinder (e.g., any of cylinders 40, 40′, 40″, 40″′, etc.). The system then reads the rotational information of the respective cylinder and fires the pulser/receiver. In some aspects, the system 300 with any herein disclosed encoder system acquires the data from the ultrasonic inspection which is then analyzed for thickness and defect information and the results are displayed.

The method may include arranging at least a portion of a cylinder in a measuring position relative to a plurality of rollers and an encoder system of a non-direct drive ultrasonic scanning system. The method may include spinning, by the plurality of rollers, the cylinder. The method may include moving an ultrasonic transducer into proximity with the cylinder. The method may include detecting, by the encoder system, a rotary position of a portion of the cylinder. The method may include synchronizing, based on the rotary position, rotational and translational motion of an ultrasonic transducer of the non-direct drive ultrasonic scanning system. The method may include determining, using the rotary position and signals from the ultrasonic transducer of the non-direct drive ultrasonic scanning system, whether a defect of the cylinder is present. The steps of the method may be varied, modified, or performed in a different order as desired. The steps of the method may include any of the features (including but not limited to encoder systems or cylinders) disclosed herein. The method may include detecting, by the ultrasonic transducer, a set of signals resulting from a set of ultrasonic pulses.

In examples, any of the systems disclosed herein may be portable.

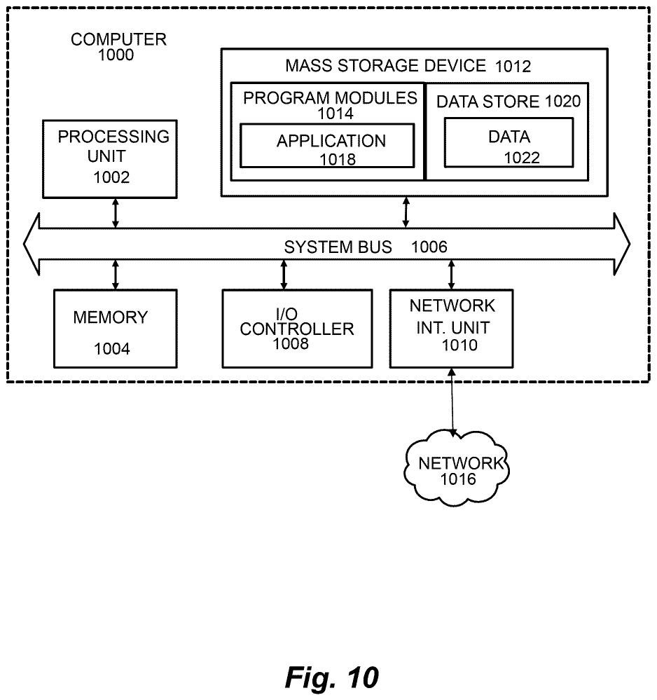

FIG. 10 is a computer architecture diagram showing a general computing system capable of implementing aspects of the present disclosure in accordance with one or more examples described herein. In any of these example implementations, computer 1000 may be configured to perform one or more functions associated with examples of this disclosure. For example, the computer 1000 may be configured to perform operations in accordance with those examples shown in FIGS. 1 to 9. It should be appreciated that the computer 1000 may be implemented within a single computing device or a computing system formed with multiple connected computing devices. The computer 1000 may be configured to perform various distributed computing tasks, in which processing and/or storage resources may be distributed among the multiple devices. A data acquisition and display computer and/or an operator console of the system shown in FIG. 10 may include one or more systems and components of the computer 1000.

As shown, the computer 1000 includes a processing unit 1002 (“CPU”), a system memory 1004, and a system bus 1006 that couples the memory 1004 to the CPU 1002. The computer 1000 further includes a mass storage device 1012 for storing program modules 1014. The program modules 1014 may be operable to analyze data from any herein disclosed components and/or control any related operations. The program modules 1014 may include an application 1018 for performing data acquisition and/or processing functions as described herein, for example to acquire and/or process any of the herein discussed data feeds. The computer 1000 can include a data store 1020 for storing data that may include data 1022 of data feeds from system components.

The mass storage device 1012 is connected to the CPU 1002 through a mass storage controller (not shown) connected to the bus 1006. The mass storage device 1012 and its associated computer-storage media provide non-volatile storage for the computer 1000. Although the description of computer-storage media contained herein refers to a mass storage device, such as a hard disk or CD-ROM drive, it should be appreciated by those skilled in the art that computer-storage media can be any available computer storage media that can be accessed by the computer 1000.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1000. “Computer storage media”, “computer-readable storage medium” or “computer-readable storage media” as described herein do not include transitory signals.

According to various examples, the computer 1000 may operate in a networked environment using connections to other local or remote computers through a network 1016 via a network interface unit 1010 connected to the bus 1006. The network interface unit 1010 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 1000 may also include an input/output controller 1008 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 1000. The bus 1006 may enable the processing unit 1002 to read code and/or data to/from the mass storage device 1012 or other computer-storage media.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state or may include rotating media storing magnetically-encoded information. The program modules 1014, which include the data feed application 1018, may include instructions that, when loaded into the processing unit 1002 and executed, cause the computer 1000 to provide functions associated with one or more examples illustrated in the figures of this disclosure. The program modules 1014 may also provide various tools or techniques by which the computer 1000 may participate within the overall systems or operating environments using the components, flows, and data structures discussed throughout this description.

In general, the program modules 1014 may, when loaded into the processing unit 1002 and executed, transform the processing unit 1002 and the overall computer 1000 from a general-purpose computing system into a special-purpose computing system. The processing unit 1002 may be constructed from any number of transistors or other discrete circuit elements, which may individually or collectively assume any number of states. More specifically, the processing unit 1002 may operate as a finite-state machine, in response to executable instructions contained within the program modules 1014. These computer-executable instructions may transform the processing unit 1002 by specifying how the processing unit 1002 transitions between states, thereby transforming the transistors or other discrete hardware elements constituting the processing unit 1002.

Encoding the program modules 1014 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer storage media are implemented as semiconductor-based memory, the program modules 1014 may transform the physical state of the semiconductor memory, when the software is encoded therein. For example, the program modules 1014 may transform the state of transistors, capacitors, or other discrete circuit elements constituting the semiconductor memory.

As another example, the computer storage media may be implemented using magnetic or optical technology. In such implementations, the program modules 1014 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain examples, the above-described data feeds may be stored in databases such as database servers that store master data, event related data, response plan data, telemetry information, and mission data as well as logging and trace information. The databases may also provide an API and/or API access (e.g., for open source) to the web server for data interchange based on JSON specifications. In some examples, the database may also directly interact with systems and monitoring devices to identify, determine, and control response operations. According to certain examples, the database servers may be optimally designed for storing large amounts of data, responding quickly to incoming requests, having a high availability and historizing master data.

In the description herein, numerous specific details are set forth. However, it is to be understood that examples of the present disclosure may be practiced without these specific details. In other instances, well-known methods, structures, and techniques have not been shown in detail in order not to obscure an understanding of this description. References to “one example,” “an example,” “examples,” “some examples,” “certain examples,” “various examples,” etc., indicate that the example(s) of the present disclosure so described may include a particular feature, structure, or characteristic, but not every example necessarily includes the particular feature, structure, or characteristic. Further, repeated use of the phrase “in one example” does not necessarily refer to the same example, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain examples of the present disclosure are described above with reference to block and flow diagrams of systems and methods and/or computer program products according to examples of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some examples of the present disclosure.

These computer-executable program instructions may be loaded onto a general-purpose computer, a special-purpose computer, a processor (e.g., a processor chip, single/multi-processor architectures, sequential (Von Neumann)/parallel architectures, and specialized circuits, etc.), or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

While certain examples of the present disclosure have been described in connection with what is presently considered to be the most practical and various examples, it is to be understood that the present disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the present disclosure, including the best mode, and also to enable any person skilled in the art to practice certain examples of the present disclosure, including making and using any devices or systems and performing any incorporated methods. The patentable scope of certain examples of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed examples, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

1. A non-direct drive cylinder defect detection system, comprising:
a non-direct drivetrain system comprising a plurality of rollers rotatably driven by a shaft, the plurality of rollers configured to receive and cause a cylinder to spin while rested thereon; and
an encoder system configured to detect a rotary position of a portion of the cylinder.

2. The system of claim 1, wherein the encoder system comprises:
a vacuum sealing cup configured to connect to an end of the cylinder during testing operations; and
a rotary encoder with a rotating shaft connected to the vacuum sealing cup, the rotary encoder configured to detect the rotary position of the end of the cylinder.

3. The system of claim 2, further comprising: a vacuum rotary union housing, wherein the rotating shaft runs from the rotary encoder through the vacuum rotary union housing.

4. The system of claim 2, wherein the vacuum sealing cup is configured to mechanically attach to the end of the cylinder by forming a vacuum seal coupling.

5. The system of claim 2, wherein a vacuum force formed between the vacuum sealing cup and the cylinder is larger than a frictional drag developed in the rotary encoder by rotation caused by the rotating shaft during testing operations.

6. The system of claim 2, wherein the cylinder is non-ferrous or ferrous.

7. The system of claim 1, wherein the encoder system comprises:
a connector plate driven by a rotating shaft and configured to connect to an end of the cylinder, the connector plate being at least partially magnetic or comprising one or more magnetic connectors; and
a rotary encoder coupled to the rotating shaft that runs from the rotary encoder through the connector plate, the rotary encoder configured to detect the rotary position of the end of the cylinder.

8. The system of claim 7, wherein a magnetic force formed between the connector plate and the cylinder is larger than a frictional drag developed in the rotary encoder by rotation caused by the rotating shaft during testing operations.

9. The system of claim 7, wherein the cylinder is ferrous.

10. The system of claim 7, wherein the cylinder comprises a ferrous connector positioned on the end of the cylinder to form the magnetic force between the cylinder and the connector plate.

11. The system of claim 1, wherein the cylinder comprises a base end with a first coupling pattern, wherein the encoder system comprises:
a mounting plate configured to connect to an end of the cylinder, the mounting plate comprising a second coupling pattern shaped to connect with the first coupling pattern; and
a rotary encoder coupled to the mounting plate, the rotary encoder configured to detect the rotary position of the end of the cylinder.

12. The system of claim 11, wherein the first coupling pattern is formed in the base end by one or more notches selectively positioned to align with the mounting plate.

13. The system of claim 11, wherein during testing operations, the second coupling pattern of the mounting plate is configured to mechanically lock and unlock with the first coupling pattern of the base end of the cylinder.

14. The system of claim 1, wherein the cylinder comprises an encoder ring pattern positioned on a base end, wherein the encoder system comprises an optical encoder configured to detect the rotary position of the base end of the cylinder by tracking rotational motion of the cylinder by reading position information of the encoder ring pattern during testing operations.

15. The system of claim 14, wherein the encoder ring pattern is engraved or otherwise shaped with the base end of the cylinder.

16. The system of claim 14, wherein the encoder ring pattern is scribed, laser etched, and/or otherwise mechanically formed with the base end of the cylinder.

17. The system of claim 14, wherein the optical encoder comprises a spectrophotometer or a color encoder, and wherein the encoder ring pattern comprises a color gradient to measure the rotary position of the cylinder during testing operations.

18. The system of claim 17, wherein the color gradient of the encoder ring pattern is attached or otherwise adhered to the cylinder.

19. The system of claim 1, wherein the portion of the cylinder detected by the encoder system is a base portion of the cylinder.

20. The system of claim 1, further comprising:
an adjustable receiving/transmitting transducer positioned to mount proximal to the cylinder.

21. The system of claim 1, the non-direct drivetrain system comprises a motor coupled to a gear box, wherein the gear box is coupled to an output shaft that passes through a bearing housing mounted in a wall of a fluid tank and into contact with the plurality of rollers.

22. The system of claim 1, further comprising a fluid tank for providing fluid for use in testing operations.

23-25. (canceled)

26. A method of testing for the presence of a cylinder defect, comprising:
arranging at least a portion of a cylinder in a measuring position relative to a plurality of rollers and an encoder system of a non-direct drive ultrasonic scanning system;
spinning, by the plurality of rollers, the cylinder;
moving an ultrasonic transducer into proximity with the cylinder;
detecting, by the encoder system, a rotary position of a portion of the cylinder;
synchronizing, based on the rotary position, rotational and translational motion of an ultrasonic transducer of the non-direct drive ultrasonic scanning system; and
determining, using the rotary position and signals from the ultrasonic transducer of the non-direct drive ultrasonic scanning system, whether a defect of the cylinder is present.

27. The method of claim 26, wherein the encoder system is the encoder system of claim 1.

28. The method of claim 26, wherein the cylinder is the cylinder according to claim 1.

29. The method of claim 26, further comprising:
detecting, by the ultrasonic transducer, a set of signals resulting from a set of ultrasonic pulses.
